(19) United States
(12) Patent Application Publication
(10) Pub. No.: US 2011/0153339 A1
(43) Pub. Date: Jun. 23, 2011

(54) Multi-Site Club Membership

(75) Inventors: Bill Buck, Markham (CA); Tony Borges, Brooklin (CA); Greg Gerald, Toronto (CA); Patty Dimonte, North York (CA); Chris Lakerdas, North York (CA)

(73) Assignee: JONAS SOFTWARE, Richmond Hill (CA)

(21) Appl. No.: 12/686,072

(22) Filed: Jan. 12, 2010

(30) Foreign Application Priority Data
Dec. 23, 2009 (CA) NYA

(51) Int. Cl. G06Q 10/00; G06Q 30/00; G06Q 50/00; G06Q 99/00; G06F 17/30

(52) U.S. Cl. 705/1.1; 705/34; 707/733; 707/E17.059

(57) ABSTRACT

A method for member profile maintenance in a multi-site membership arrangement of two or more affiliate clubs, the member profile including a plurality of member data fields, the method including associating the member profile with a home club and storing the member profile on a home database at the home club, replicating the member profile to one or more affiliate databases at one or more affiliate clubs, and synchronizing information stored on the plurality of member data fields of the member profile between the home database and the one or more affiliate databases upon activation of an update mechanism.

### FIELD OF THE INVENTION

The present invention relates to a system and method for club membership management, and more specifically relates to a system and method for the control and management of member profiles across a number of affiliated golf clubs.

### BACKGROUND OF THE INVENTION

In the art of golf club membership management, it has become commonplace for a number of different golf clubs to engage in relationships whereby members of a particular club are afforded partial or full membership privileges at affiliated clubs. This allows for strategic business relationships between clubs and allows members to be better serviced by providing the ability to play at different clubs while maintaining only a single membership.

One possible way of maintaining a membership database while allowing access to members of affiliated clubs is to provide for a common member database, where all clubs within the organization have access to, and share a single member database. This can be problematic, however in that control and access to the database is not restricted. Furthermore, the database may become excessively large leading to slower service for members when access to the database is required, for example, when visiting affiliate clubs or requiring updates to the membership information. Furthermore, when a new club is added to the arrangement, access to the entire database must be restricted to enter the membership information of all members at the new club.

Older systems also provided for completely separate member databases at each club and merely allowed for the recognition of a member, for example, based on an access card, when visiting an affiliate club. Such an arrangement, while providing sufficient access, has limitations in that members cannot be serviced at an acceptable level at the affiliate clubs. For example, while a member will be allowed entry to the affiliate club, the member's information is otherwise not accessible and the member is generally indistinguishable from a guest at the club.

Accordingly, there is a need in the art for an improved system and method for maintaining, or otherwise managing, membership information across an organization of affiliated clubs, and specifically golf clubs.

### SUMMARY OF THE INVENTION

According to a first embodiment of the present invention there is disclosed a method for member profile maintenance in a multi-site membership arrangement of two or more affiliate clubs, where the member profile includes a plurality of member data fields, and the method includes associating the member profile with a home club and storing the member profile on a home database at the home club, replicating said member profile to one or more affiliate databases at one or more affiliate clubs, and synchronizing information stored on the plurality of member data fields of the member profile between the home database and the one or more affiliate databases upon activation of an update mechanism.

According to one aspect of the first embodiment, the update mechanism is a detection of a change in information on any one of said plurality of member data fields, such that said synchronizing step is performed in real time.

According to another aspect of the first embodiment, the method may include associating an affiliation type with each member profile and storing an affiliation code on one of the plurality of member data fields, where the affiliation code is representative of the affiliation type. The affiliation type preferably contains information representative of one or more of a member's home club, a member's privileges at said home club, a member's privileges at affiliate clubs, and a golfer classification. The golfer classification defines at least one of a level of access to golf facilities at a one or more clubs and tee time booking restrictions at one or more clubs.

According to another aspect of the first embodiment, the method includes storing in the one or more data fields, an indicator a member's home club. The method may further include monitoring the member's account activity at each of the two or more clubs in the multi-site membership arrangement and transferring all charges accrued at each of the two or more clubs to the member's home club, such that a single statement of account of all charges accrued by the member at each of the two or more clubs in the multi-site membership arrangement may be provided.

According to a second embodiment of the present invention, there is disclosed a system for multi-site membership maintenance including (a) a member profile stored on a home database at a club, the member profile including a plurality of member data fields, (b) a replicating module for replicating the member profile to one or more affiliate databases at one or more affiliate clubs, and (c) a synchronizing module for synchronizing information stored on the plurality of member data fields between the home database and the one or more affiliate databases upon activation of an update mechanism.

According to one aspect of the second embodiment, the update mechanism detects a change in information on any one of the plurality of member data fields, and subsequently performs the synchronizing such that the synchronizing is performed in real time.

According to another aspect of the second embodiment, an affiliation type is associated with each member profile and affiliation code is stored on one of the plurality of member data fields, the affiliation code representative of the affiliation type. The affiliation type may indicate one or more of a member's home club, a member's privileges at said home club, a member's privileges at affiliate clubs, and a golfer classification. The golfer classification preferably defines at least one of a level of access to golf facilities at a one or more clubs and tee time booking restrictions at one or more clubs.

According to another aspect of the second embodiment, an indicator of a member's home club is stored in said one or more data fields. The system may further comprise a monitoring module for monitoring a member's account activity at each of the two or more clubs in the multi-site membership arrangement and transferring all charges accrued at each of the two or more clubs to the member's home club. Preferably, an account module is provided to provide a single statement of account of all charges accrued by the member at each of the two or more clubs in the multi-site membership arrangement.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which presently preferred embodiments of the invention will now be illustrated by way of example only. In the drawings, like reference numerals depict like elements. It is expressly understood, however, that the drawings are for the purpose of illustration and description only and are not intended as a definition of the limits of the invention.

FIG. 1 is a flow diagram schematically showing the system of the present invention.

FIG. 2 shows an exemplary software representation of the multi-site arrangement of the present invention.

FIG. 3A shows an exemplary software implementation of affiliation codes as used in the system of FIG. 1.

FIG. 3B shows an additional affiliation codes possible in the software implementation of FIG. 3A.

FIG. 4 shows an exemplary member profile.

FIG. 5 shows custom information as may be included in the profile of FIG. 4.

FIG. 6 shows an exemplary software implementation of a particular club setup of the arrangement of FIG. 2.

FIG. 7 shows an exemplary software implementation of an account module for use with the present invention.

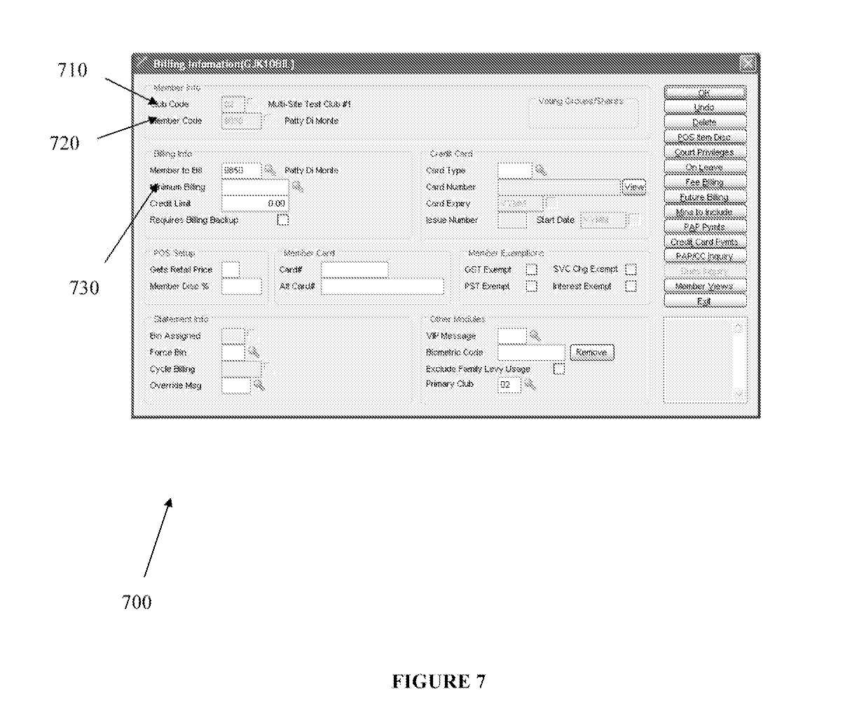

FIG. 8 is a flowchart showing the steps in the method of the present invention.

FIG. 9 is a flowchart showing additional steps of the method of FIG. 8.

### DETAILED DESCRIPTION OF THE PREFERRED EMBODIMENTS

In an arrangement among golf clubs where members of a home club are afforded full, partial, or limited benefits at one or more additional clubs, the present invention provides a method and system for managing member profiles between the home club and the one or more additional clubs. For the purposes of this description, the combination of the home club and all additional clubs having a relationship with the home club, where members are afforded any mutual benefits will be referred to as an organization. It will be understood that the individual clubs within an organization as herein described may or may not be owned, controlled, or otherwise managed by the same entity. Rather, the term organization is used to refer to any arrangement of a plurality of clubs where members are afforded full, partial, or limited mutual benefits, as can be determined by each individual club with respect to every other individual club where such an arrangement of benefits exists.

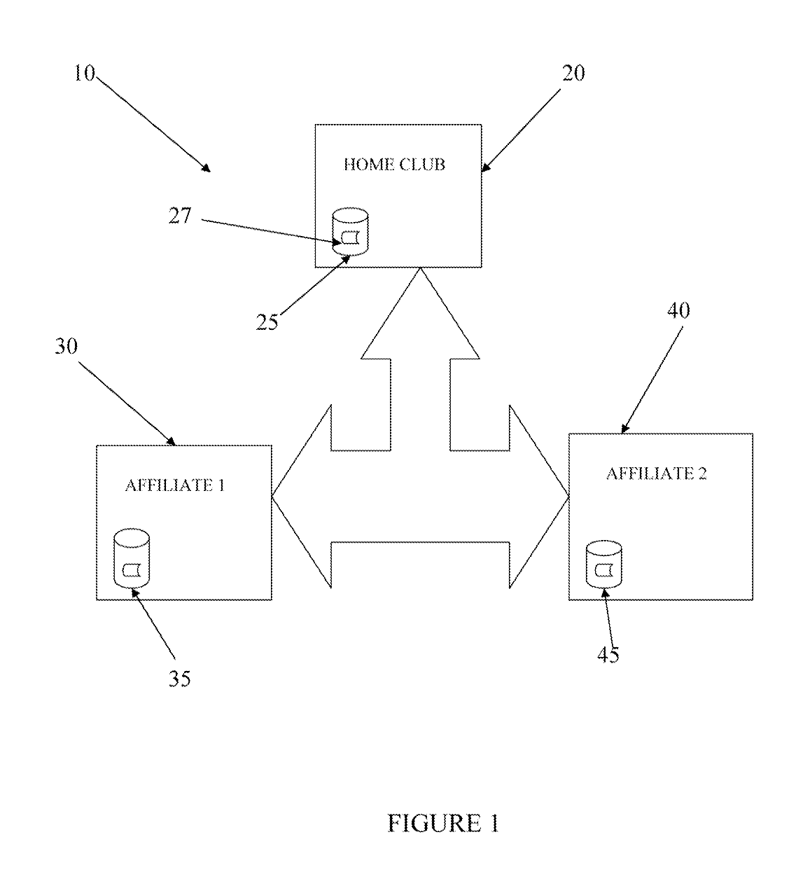

Preferably, the method and system will be implemented on a computer readable medium, such as a database, where each of the clubs in the organization will have a separate database, each of which has software installed thereon for communicating with other databases and thereby carrying out the method of the present invention. In particular, and referring now to FIG. 1, the present invention contemplates an organization of at least two, and preferably more than two, golf clubs having agreements between each other, or agreements as an organization as a whole, to afford full, partial or limited benefits to individual members of each club's members. It is further contemplated that no benefits may also be afforded where clubs have an otherwise business relationship and wish to exchange membership information, but not to afford such benefits as described. In FIG. 1, the organization 10 is shown to include a home club 20, a first affiliate club 30 and a second affiliate club 40. It will be understood that any number of clubs may form part of the organization. The term home club is used as a reference only. In practice, all clubs in the organization will be a home club for those members based at the particular club.

Each club 20, 30 and 40 has a membership database 25, 35, 45 associated with the respective club, and as will be further described below, the member databases 25, 35 and 45 have member profiles, for example as shown as member profile 27 at the home club 20, from each database replicated thereon and synchronized, either in real-time, or upon activation of an update mechanism. Each member profile includes a plurality of member data fields storing information regarding a particular member. For example, member data fields may include fields indicative of a particular member's personal information, membership status, club preferences and other fields as will be appreciated from the description of the present invention and those already known to those skilled in the art.

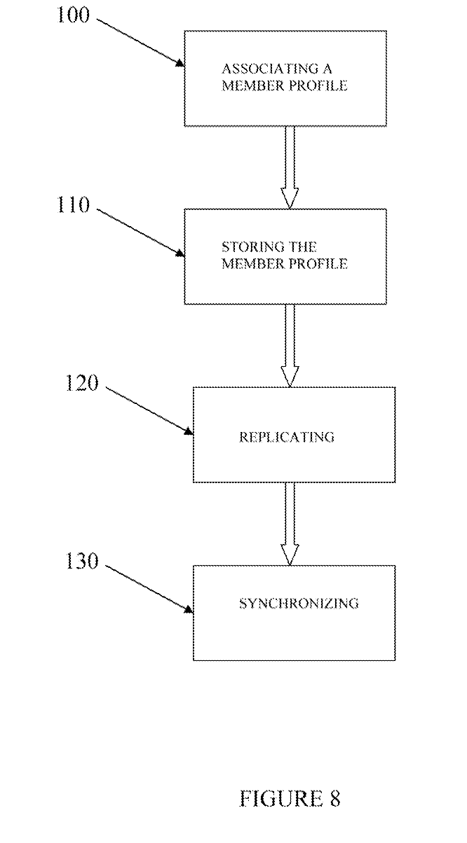

According to one embodiment of the present invention, a method of member profile management in a multi-site membership arrangement of two or more clubs is disclosed, as shown in FIG. 8. The method includes the steps of associating the member profile with a home club 100, storing the member profile on a home member database 110 at the home club, replicating the member profile on one or more member databases at one or more member clubs 120 and synchronizing information stored on the plurality of member data fields of the member profile between the home database and the one or more member databases 130 upon activation of an update mechanism.

Preferably, the update mechanism provides real-time synchronization of member profiles among all databases and accordingly, the update mechanism is preferably a detection of a change in information on any of the member data fields. This may be implemented, for example, by comparing member profiles across the organization at periodic intervals. When a difference is observed in the same profile as it exists at multiple clubs, the update mechanism may be activated and accordingly, information stored in that particular member database is synchronized across the organization.

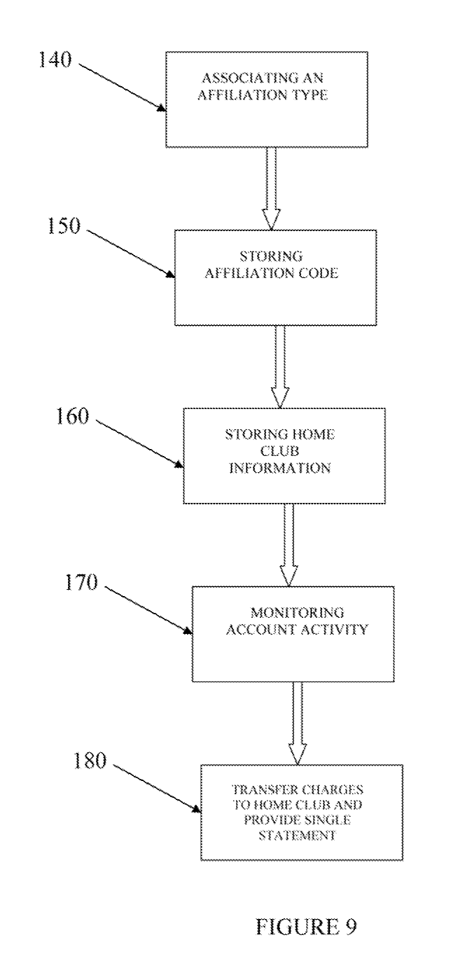

Referring to FIG. 9, the method preferably further includes associating an affiliation type with a member profile 140 and storing an affiliation code on one of the plurality of member data fields 150, where the affiliation code is representative of the affiliation type. The affiliation type preferably contains information representative of one or more of a member's home club, a member's privileges at said home club, a member's privileges at affiliate clubs, and a golfer classification. The method may further comprise storing in one of the data fields, an indicator of the member's home club 160, monitoring a member's activity at all clubs in the organization 170 and transferring all charges accrued across the organization back to the member's home club to provide a single statement of account for the member 180. Specific details and other advantages of these method steps will now be described.

The member profile, preferably includes a data field storing an affiliation code representative of a particular affiliation type. The affiliation codes are typically selected from a group of predefined affiliation codes that may be used when membership profiles are created. Affiliation codes according to the present invention will determined particular access levels of a given member at the member's home club and at clubs across the organization. Thus, as changes are made, for example in billing arrangements or access level arrangements between different clubs within the organization, only the affiliation code definitions need to be changed and all such adjustments will be applied to those members with the given affiliation code.

The inclusion of the affiliation code, and such affiliation code definitions, across the databases of each club belonging to the organization and within each member profile at each club allows for robust management of member profiles, as will be apparent from the description below. As there is no restriction on the number of possible affiliation types, various levels of interclub arrangements within the organization may be easily defined and implemented without unduly onerous modifications to the member databases at each club. Such arrangements and access levels of a member belong to one club, at all other clubs within the organization can be driven by the affiliation code and it's definition. It will be understood that while the present invention has been described with reference to an affiliation code, other implementations of the same functionality are also contemplated.

More specifically, the affiliation code is an implementation of a single identifier of a member's status within an organization, and an identifier of particular inter-club agreements and relationships that affect the member's status when visiting affiliate clubs.

The affiliation codes and the particular definitions are adapted to provide for three preferred factors of the present invention, where each affiliation code provides at least an indication of a home club associated with that affiliation code: (a) allows all home clubs within the organization to recognize members across some or all of their affiliated clubs, (b) allows for the transfer of charge accrued at all clubs within the organization to be transferred back to the member's home club, and (c) controls when a member can perform select activities, such as making tee time reservations based on each member's classification level. It will be apparent to those skilled in the art that all of the above will be driven by the affiliation code stored on a member profile, and defined at the club level, such that individual member profiles need not be updated whenever changes are made. Rather, only the affiliation definitions will be modified or updated and therefore such changes will be reflected instantly across all member profiles in the organization.

It will be understood by those skilled in the art that the present invention provides for a method and system of maintaining membership profiles, or membership information, across a plurality of clubs without the use of a common database shared by each of the properties. This facilitates the addition of member clubs and provides for a more robust and dynamic method of maintaining, updating, and otherwise servicing member profiles. A preferred embodiment and one implementation of the present invention will now be described.

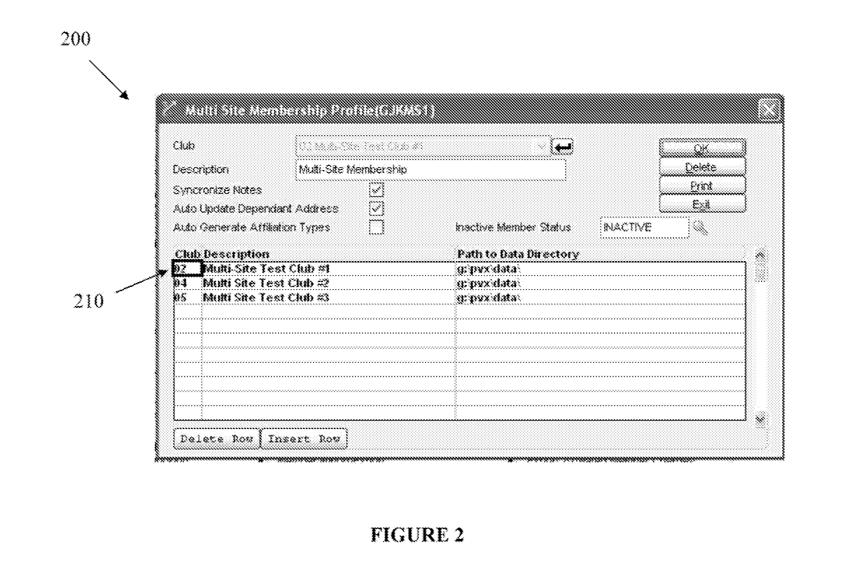

Referring now to FIG. 2, there is shown an exemplary implementation of an interface 200 identifying all clubs belonging to the organization, as herein defined. It will be apparent that any number of clubs may be added to this database, and each club will be assigned a unique club code 210. The unique club codes 210 apply at the organization level, and must be common at the databases of each particular club. As this list and identification of clubs belong to the same organization is created, or edited to include new clubs, the club names, codes and other possible identifiers are copied to all other clubs within the organization as well. In summary, the interface 200 of FIG. 2 provides a top level identification of all clubs belonging to the organization using the multi-club membership method and system according to the present invention.

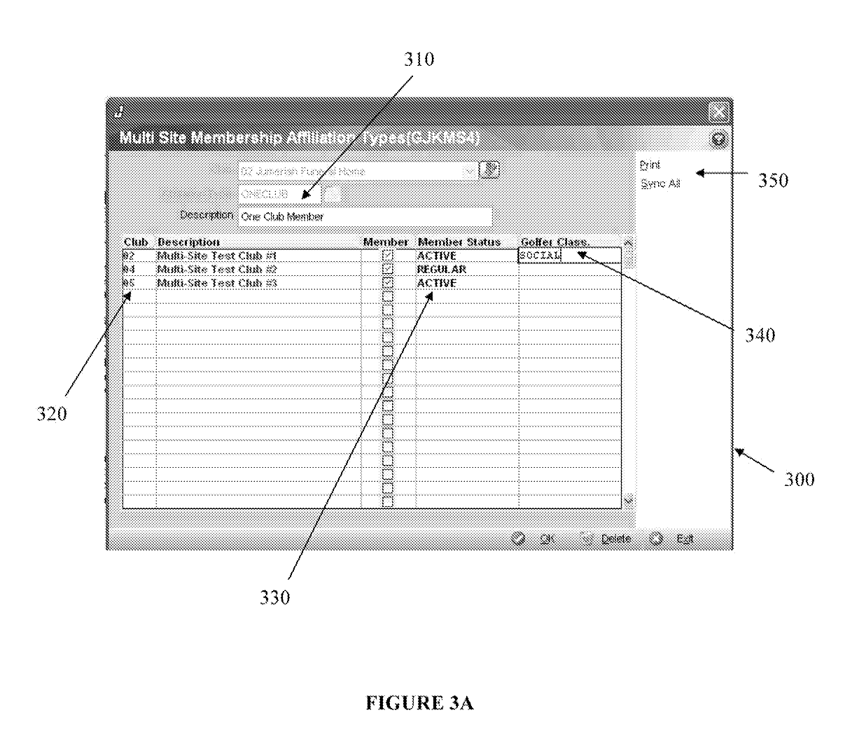

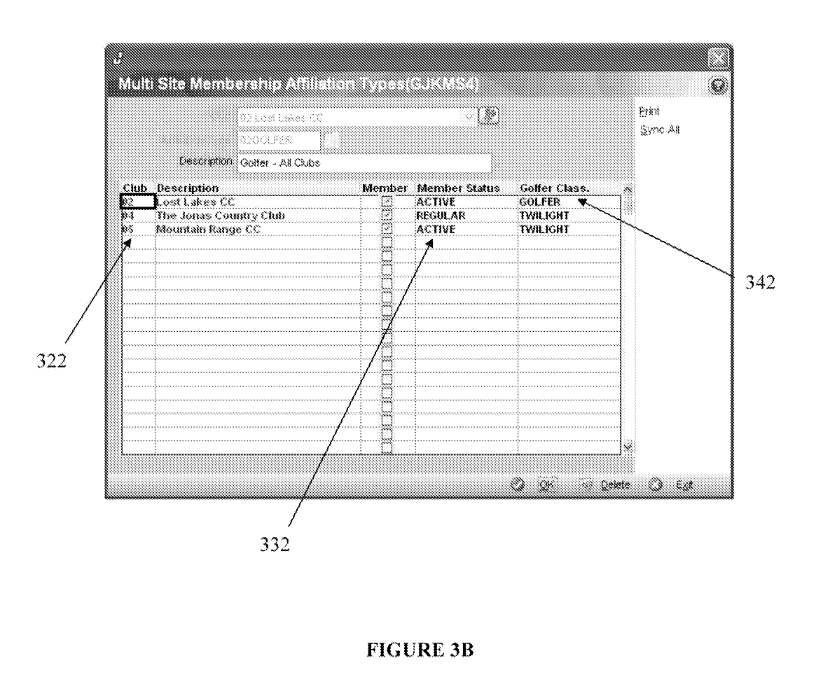

Once the top level identification of all clubs has been stored in databases across the organization, the sharing of member profiles and the providing of access to other clubs in the organization is directed by a number of different affiliation types. Shown in FIG. 3A, is a representative implementation 300 of an affiliation code definition at a particular club, that may ultimately be referenced by and included in any number of member profiles. The affiliation code 310 is representative of, or otherwise defines, a particular affiliation type, and the member status such affiliation type is afforded at affiliate clubs. As shown in FIG. 3, the club called, “02-Jumeriah” has an affiliation type “ONECLUB” as applied to three different affiliate clubs 320. A member status 330 is defined such that a member of Jumeriah has an “Active” member status at “Multi-Site Test Club #1” and a “Regular” status at “Multi-Site Test Club #2”.

Furthermore, a golfer classification 340 may also be associated with a particular affiliation code as applied to a particular affiliate club. For example, “Jumeriah” may have an affiliate agreement with “Multi-Site Test Club #1” affording golfers belong to “Jumeriah” a social-only membership at “Multi-Site Test Club #1”. A convenient “Synch All” function 350 may be provided to synchronize affiliate definitions and update member profiles across all clubs belonging to the organization. It will be understood by those skilled in the art, that both the affiliate type and any other details of a member profile may be updated across the organization.

FIG. 3B shows a more detailed example of affiliation code definitions. In FIG. 3B, a member having the affiliation type of “02GOLFER” is shown to have membership privileges at three different clubs 322, Lost Lakes CC, The Jonas Country Club, and Mountain Range CC. The member having this affiliation type is also afforded a membership status at these respective clubs as shown at 332, and has a golfer classification with full privileges at Lost Lakes CC, but only “Twilight” privileges 342 at the other clubs, thereby only allowing for evening tee times, for example.

In general, a member's home club will maintain a complete member profile, and may contain any such information that the home club requires. However, certain information from a member profile, for example, the member's name, affiliate type, address, and picture, will be included to be shared with all affiliate clubs, and provisions will be provided that such common information to be shared must have equivalent fields in the databases of each affiliate club. Furthermore, particular clubs may have custom information stored on any or all members of the organization as would be deemed relevant, for example, particular visitation dates, customized spending reports and other types of information. Therefore, a member profile may exist in any form at all clubs in the organization, with only specific fields on the member profile shared and synchronized across the organization. It will be understood that the fields to be shared, in those applications where the entire member profile is not shared, will have to be predetermined and common among all clubs.

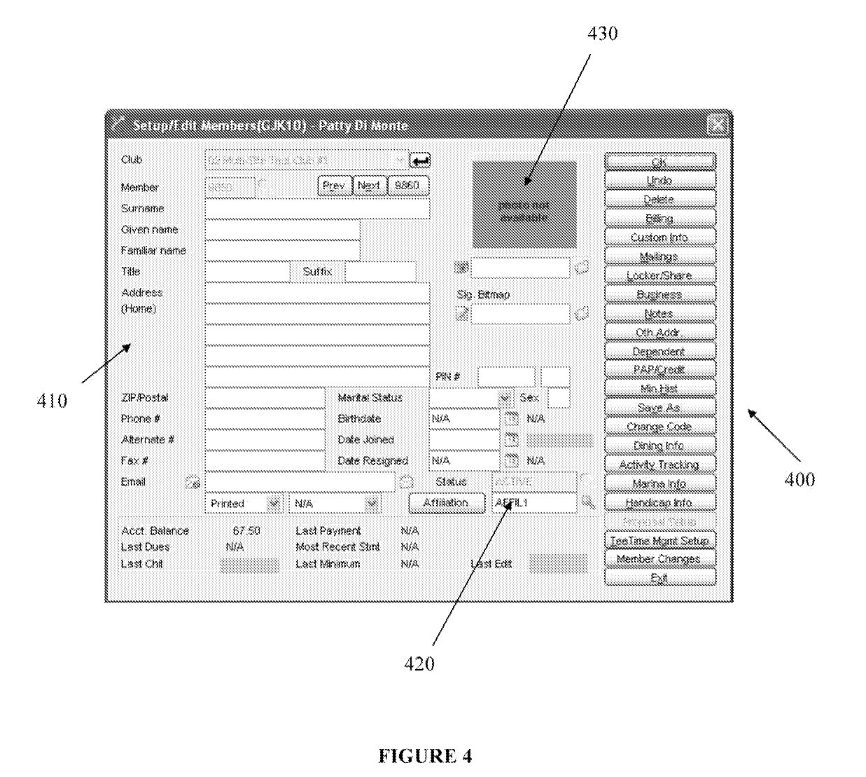

FIG. 4 shows an exemplary screenshot 400 of the set-up of a member profile, and select information stored in various fields of the member profile 410. Basic identification information is stored, as well as an indication of a particular affiliation type 420 associated with the member. Preferably, the affiliation type can be changed directly from the member set up page 400. Thus, all inter-club activities within the organization and access levels of members at affiliate clubs can easily be updated, modified, or added simply by changing the affiliation type on a member profile. The affiliation type as selected in the member profile will be one that has previously been defined. Preferably, the member profile also includes a summary of account activity. As will be described in greater detail below, including the account summary with the member profile, and synchronizing the member profile across all clubs in the organization allows for a member's outstanding account balance and charges accrued to be managed from a single club, preferably the member's home club.

Preferably, a member photo 430 is also stored as part of the member profile. The member photo 430 preferably forms part of the data that is synchronized between all clubs in the organization, such that when a particular member visits an affiliate club, and identifies themselves upon entry, either by way of a scan-card, or similar device, or by name, the member photo may be displayed to an attendant to ensure the appropriate member is provided access to the club.

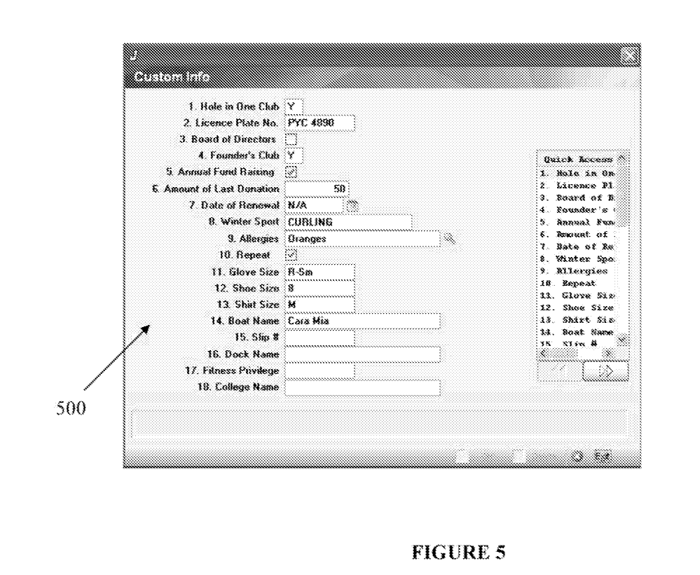

In addition, a number of custom data fields may also form part of the member profile. FIG. 5 shows one embodiment of certain custom data fields 500. Such custom data fields may or may form part of the data that is synchronized across all clubs. Preferably, all data is synchronized and shared among all member clubs, but it would be appreciated by those skilled in the art that certain types of data may be held exclusively at a member's home club, or at any other particular club.

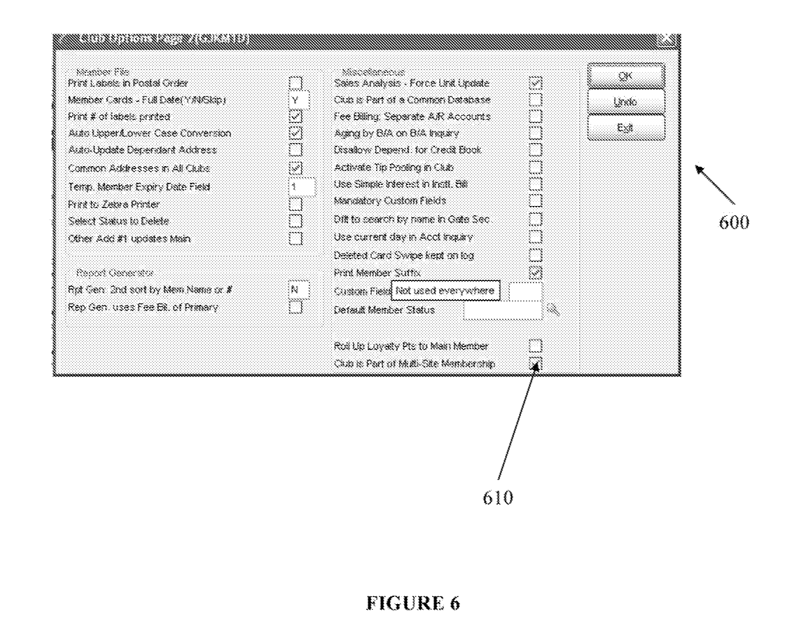

Referring now to FIG. 6, a preferred implementation of a club level set-up 600 is shown. Each club in the organization preferably includes a top level set up with options available similar to those shown in FIG. 6. Furthermore, such an arrangement allows a number of different clubs, running the same software to opt-in to the multi-site membership arrangement.

According to another aspect of the present invention, the affiliation code associated with each member profile will also have information contained therein indicative of a member's home club. Alternatively, a member's home club may be stored as part of the member profile, but not associated with the affiliation code. As embodied in FIG. 4, information on a member's home club is a static field forming part of the member profile. Preferably, a primary club code is assigned to each member, either as being included in the affiliation code, or separately therefrom. The primary club code may be used to control access to the member profile, for example, to restrict access to specific member fields at the affiliate clubs. In this manner, certain primary member fields can be controlled from a single point of ownership, namely the member's home club. Examples of such primary fields may include, the definition of the member's home club, the member's account and billing information, and key biographic information. All other membership fields are available to be edited at affiliate clubs.

Furthermore, the inclusion of the primary club code provides for an automated batch transfer of all charges accrued by a member at affiliate clubs back to the member's home club. In this manner, a member will be provided with a single, periodic statement detailing all charges from across the organization, but will only be billed from the home club. Accordingly, each club will have predefined inter-organizational relationships with every other club to facilitate the transfer of member charges. In this manner, detailed reports may be provided that outline charges from specific clubs across the organization. Furthermore, this updating and batch transfer of charges provides for better servicing of member account information as charges are routinely and periodically applied to accounts at the member's home club, and does not require a specific request to be made by each home club for charges accrued at affiliate clubs.

The inclusion of a system as previously described, whereby all charges accrued by a member across all clubs in the organization are transferred back to the home club, preferably to be payable to the home club and displayed as a single statement of account further allows for flexibility in inter-club arrangements. For example, different rates for products and services may be applied based on an existing membership, or club arrangement, as would be expressed in the member's affiliate code. Furthermore, clubs may transfer charges owed to other clubs in single transactions at predefined periods thereby facilitating the billing cycles and account management. Accordingly, the method of the present invention optionally further includes the transferring of all member charges back to the member's home club and further creating a general ledger of charges owed between clubs that can be periodically reconciled independently of particular members settling their own accounts.

It will be further understood by those skilled in the art that the system and method of the present invention allows for inter-club agreements and relationships to be defined with specific detail regarding access to members, accounting, transfer of member information and others. All such information may be captured in the definitions of particular affiliation types and will therefore become inherent in member profiles as they are updated at databases of particular clubs. Accordingly, as earlier described, changes in relationships and agreements between different clubs can be adjusted in practice by changing an affiliation type definition, or alternatively, by providing a new affiliation code. Therefore, there is minimal disruption in servicing members when changes are made at the organizational level.

Furthermore, when a member visits an affiliate club, restrictions on the use of the affiliate club are automatically known and implemented by way of the affiliation code associated with the member profile and/or the golfer classification as defined by way of the affiliation code. For example, a golfer having a limited membership at the home club will then have a limited membership at the affiliate club. A typical scenario occurs where a member purchases a reduced rate membership, allowing the member to only register tee times at off-peak hours. When visiting an affiliate club, this same limitation will apply as the database at the affiliate club will interpret the affiliation code associated with the member profile in the same way. This can also be used where arrangements between clubs allow members of another club to only register tee times at off-peak hours. The affiliation code definition in this case will indicate that a golfer from a particular home club can only register off-peak tee times at a particular affiliate club where such mutual benefits form part of the member sharing arrangement between the two clubs.

According to another embodiment of the present invention, the method as herein described may be implemented on a system for multi-site membership maintenance including (a) a member profile stored on a home database at a club, the member profile including a plurality of member data fields, (b) a replicating module for replicating the member profile to one or more affiliate databases at one or more affiliate clubs, and (c) a synchronizing module for synchronizing information stored on the plurality of member data fields between the home database and the one or more affiliate databases upon activation of an update mechanism.

With reference to FIG. 1, the member profile 27 is stored on a home database 25 at a respective home club 20. A replicating and synchronizing module are also stored on the database 25 and contain software for carrying out the appropriate functions. The replicating module is adapted to replicate the member profile 27 on the home database 25 to one or more affiliate databases 35, 45, for example, at one or more affiliate clubs 30, 40. The replicating module, may comprise various instructions and software for carrying out such instructions for copying, duplicating, or otherwise transferring the member profile and any associated information from the home database to any affiliate databases. The synchronizing module may comprise various instructions and software for carrying out such instructions to periodically update information that has changed, or been otherwise modified, among any of the home or affiliate databases.

Optionally, a monitoring module may be provided for monitoring a member's account activity at each of the two or more clubs in the multi-site membership arrangement and transferring all charges accrued at each of the two or more clubs to the member's home club, in accordance with the method as described above. Furthermore, an account module may be provided for providing a single statement of account of all charges accrued by a member across all clubs within the organization, in accordance with the method as described above.

Thus, it is apparent that there has been provided, in accordance with the present invention, a protective covering system which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

What is claimed is:

1. A method for member profile maintenance in a multi-site membership arrangement of two or more affiliate clubs, said member profile including a plurality of member data fields, said method comprising:
associating said member profile with a home club and storing said member profile on a home database at said home club;
replicating said member profile to one or more affiliate databases at one or more affiliate clubs;
synchronizing information stored on said plurality of member data fields of said member profile between said home database and said one or more affiliate databases upon activation of an update mechanism.

2. A method for member profile management according to claim 1, wherein said update mechanism comprises a detection of a change in information on any one of said plurality of member data fields, such that said synchronizing step is performed in real time.

3. A method for member profile management according to claim 1, further comprising associating an affiliation type with each member profile.

4. A method for member profile management according to claim 3, further comprising storing an affiliation code on one of said plurality of member data fields, said affiliation code representative of said affiliation type.

5. A method for member profile management according to claim 4, further comprising associating with said affiliation type information representative of one or more of a member's home club, a member's privileges at said home club, a member's privileges at affiliate clubs, and a golfer classification.

6. A method for member profile management according to claim 5, wherein said golfer classification defines at least one of a level of access to golf facilities at a one or more clubs and tee time booking restrictions at one or more clubs.

7. A method for member profile management according to claim 1, further comprising storing in said one or more data fields, an indicator a member's home club.

8. A method for member profile management according to claim 7, further comprising monitoring said member's account activity at each of the two or more clubs in the multi-site membership arrangement and transferring all charges accrued at each of the two or more clubs to the member's home club.

9. A method for member profile management according to claim 8, further comprising providing a single statement of account of all charges accrued by said member at each of the two or more clubs in the multi-site membership arrangement.

10. A system for multi-site membership maintenance comprising:
(a) a member profile stored on a home database at a club, said member profile including a plurality of member data fields
(b) a replicating module for replicating said member profile to one or more affiliate databases at one or more affiliate clubs
(c) a synchronizing module for synchronizing information stored on said plurality of member data fields between said home database and said one or more affiliate databases upon activation of an update mechanism.

11. A system for multi-site membership maintenance according to claim 10, wherein said update mechanism detects a change in information on any one of said plurality of member data fields, and subsequently performs said synchronizing such that said synchronizing is performed in real time.

12. A system for multi-site membership maintenance according to claim 10, further comprising an affiliation type associated with each member profile.

13. A system for multi-site membership maintenance according to claim 12, wherein an affiliation code is stored on one of said plurality of member data fields, said affiliation code representative of said affiliation type.

14. A system for multi-site membership maintenance according to claim 13, wherein said affiliation type indicates one or more of a member's home club, a member's privileges at said home club, a member's privileges at affiliate clubs, and a golfer classification.

15. A system for multi-site membership maintenance according to claim 14, wherein said golfer classification defines at least one of a level of access to golf facilities at a one or more clubs and tee time booking restrictions at one or more clubs.

16. A system for multi-site membership maintenance according to claim 10, further comprising an indicator of a member's home club is stored in said one or more data fields.

17. A system for multi-site membership maintenance according to claim 16, further comprising a monitoring module for monitoring said member's account activity at each of the two or more clubs in the multi-site membership arrangement and transferring all charges accrued at each of the two or more clubs to the member's home club.

18. A system for multi-site membership maintenance according to claim 17, further comprising an account module for providing a single statement of account of all charges accrued by said member at each of the two or more clubs in the multi-site membership arrangement.
